(19) United States
(12) Patent Application Publication
(10) Pub. No.: US 2019/0080562 A1
(43) Pub. Date: Mar. 14, 2019

(54) PROMOTIONAL TOURNAMENT SYSTEM

(71) Applicant: Evolve Softworks LLC, Commerce, GA (US)

(72) Inventors: Troy Wade Jungmann, Leander, TX (US); Brian Christopher Bonnette, Anderson, SC (US)

(73) Assignee: Evolve Softworks LLC, Commerce, GA (US)

(21) Appl. No.: 16/126,119

(22) Filed: Sep. 10, 2018

Related U.S. Application Data
(60) Provisional application No. 62/556,148, filed on Sep. 8, 2017.

(51) Int. Cl. G07F 17/32; A63F 13/35; A63F 13/79

(52) U.S. Cl. CPC G07F 17/3276; A63F 13/79; A63F 13/35; G07F 17/3244

(57) ABSTRACT

Embodiments of the Promotional Tournament System are comprised of a game within a game. It is funded by the collection of an ante and the amount of payback to the player could be controlled exactly like a slot machine. The promotion is a self-funded promotional system that generates revenue. The Promotional Tournament System is comprised of a game, a game display, a game funding procedure, a game trigger, and an eligibility procedure.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE EMBODIMENTS

### Field of the Embodiments

The general field of the embodiments of the Promotional Tournament System is promotional gaming systems.

### Description of the Prior Art

The prior art offers various types of community games that assist in attracting and retaining players to their games. The prior art teaches slot tournament products that opened the doors to all gaming facilities for their games through various techniques consisting of games on the floor to be converted to a tournament using a pad where the tournaments do not impact either the game terminal (GT), meters, or the database. Other prior art teaches a floor wide progressive played as a secondary game that collects $0.02 ante to pay for game and uses wall mounted TVs to show a 3-reel slot that is triggered by the server based on number of spins.

### SUMMARY OF THE EMBODIMENTS

Embodiments of the Promotional Tournament System described herein are a promotional product that drives customer play to game terminals regardless of the number of machines installed. Competitive games are not enough to establish a gaming floor presence. Multiple month installations with full profit going to the casino is the normal business model. In the embodiments described herein the games comprise unique feature sets to bring unique content to the gaming floor adding to floor diversity. The challenge is to drive play to the games and holding the player on the games long enough to give them a fair evaluation. Floor placement is part of that challenge, but a solid game-wide promotional engine is required to be successful.

Embodiments of the Promotional Tournament System are comprised of a game within a game. It is funded by the collection of an ante and the amount of payback to the player could be controlled exactly like a slot machine. The promotion is a self-funded promotional system that generates revenue. The Promotional Tournament System is comprised of a game, a game display, a game funding procedure, a game trigger, and an eligibility procedure.

The Promotional Tournament System is a game within a game. A multi-tiered progressive game is displayed on a screen such as a wall mounted screen or a game terminal. The top two prizes are rolling progressives that have seed values that are configurable. When the prizes are awarded, everyone that is eligible (as defined below) is paid based upon a tiered payout algorithm. The remainder of the prizes are random winners and are treated like a typical hot seat. A hot seat is a player that is actively playing on the system that is selected to win a single prize. When the game is triggered from the server, a distinctive sound is played to alert the player of the impending spin. When the prize is awarded, the game issues a distinctive alert such as displaying a fan fair and the amount awarded.

The Promotional Tournament System will pay every player eligible at the end of the tournament and is designed to be fair regardless of game or denomination played because it does not use the game math to compete but rather a central determinant method to generate tournament results. The tournaments will be short, fast and exciting because the player will use their own credits in the tournament for in-revenue tournaments and out of revenue tournaments will be free and funded by the facility. Most slot tournaments are marketing tools to drive play or to create interest in a vendor's games and are contained within a few banks of machines and not the entire floor.

There has thus been outlined, rather broadly, the more important features of the embodiments in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1 is a flow chart of an embodiment of the Promotional Tournament System.

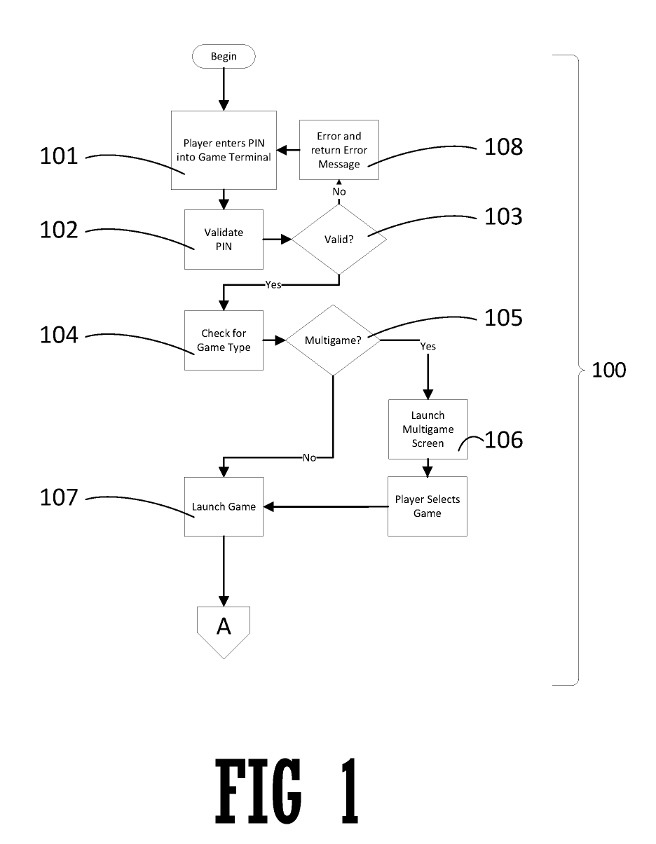

FIG. 2 is a continuation of a flow chart of an embodiment of the Promotional Tournament System.

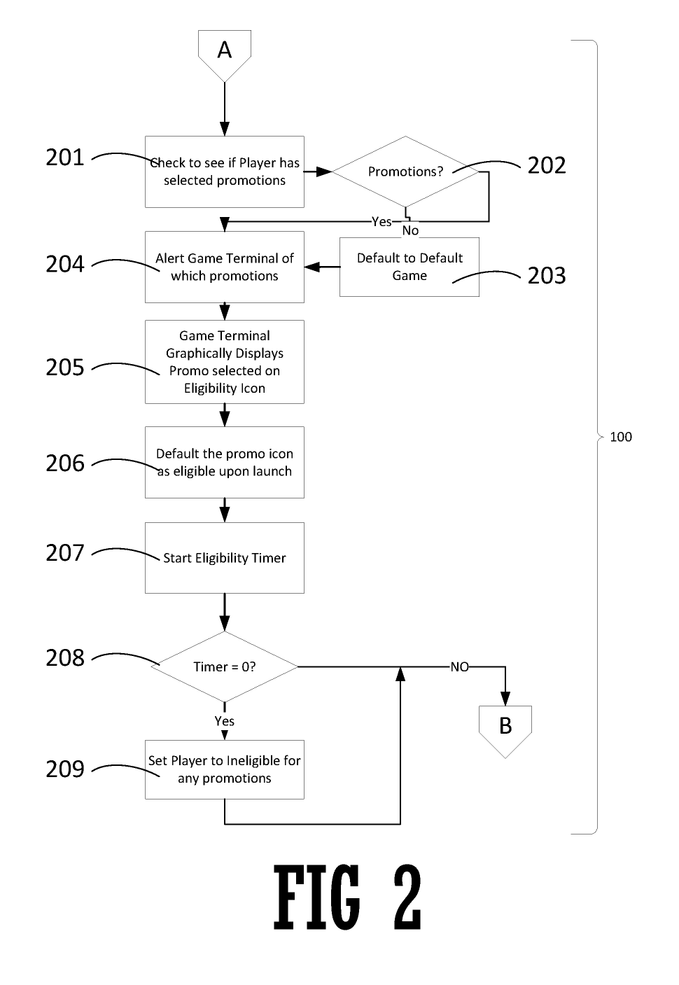

FIG. 3 is a continuation of a flow chart of an embodiment of the Promotional Tournament System.

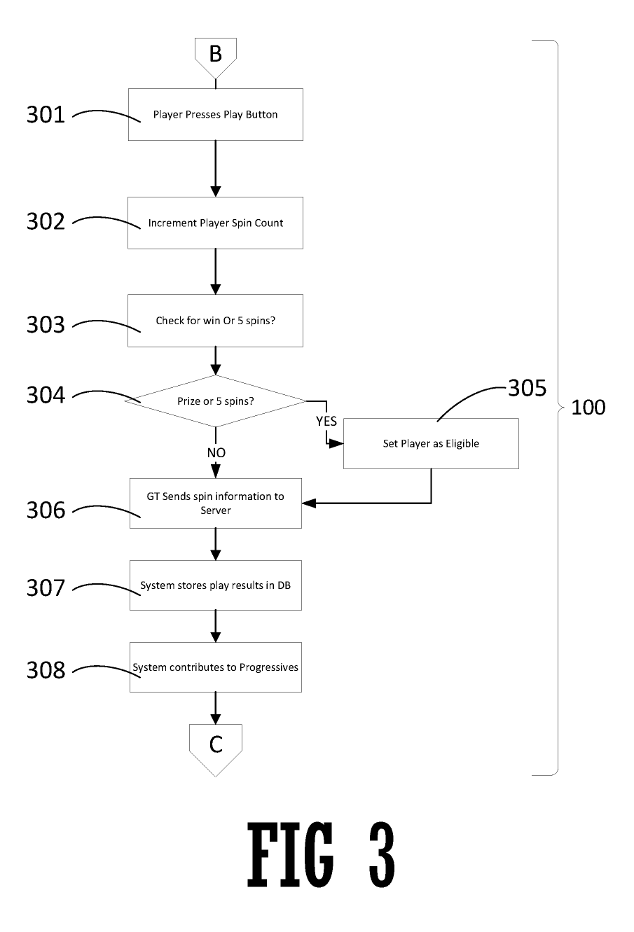

FIG. 4 is a continuation of a flow chart of an embodiment of the Promotional Tournament System.

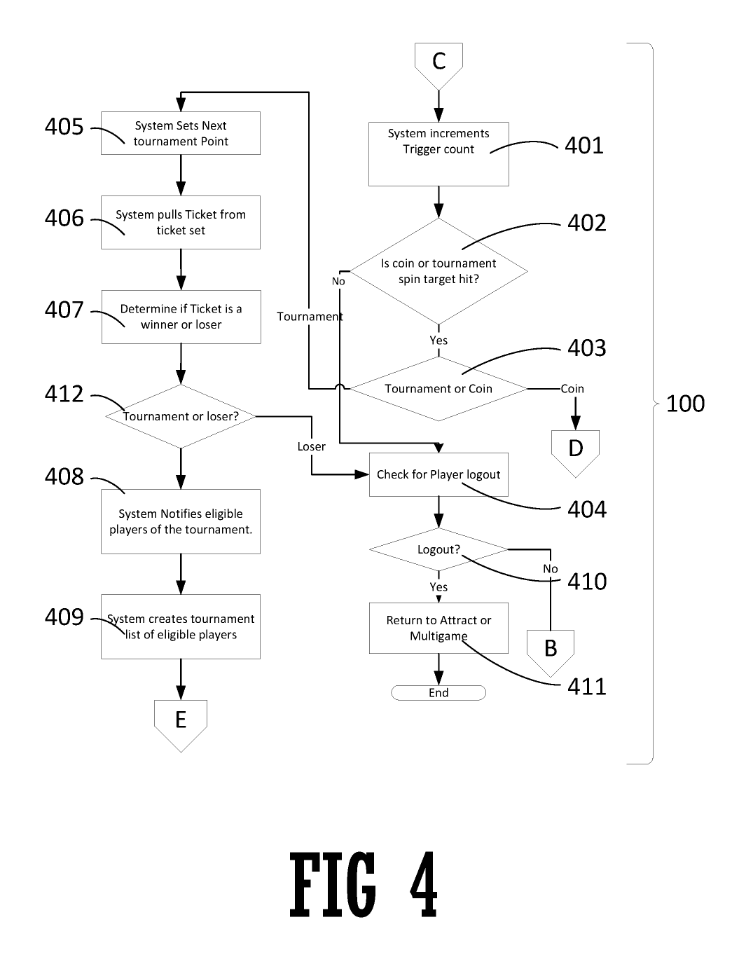

FIG. 5 is a continuation of a flow chart of an embodiment of the Promotional Tournament System.

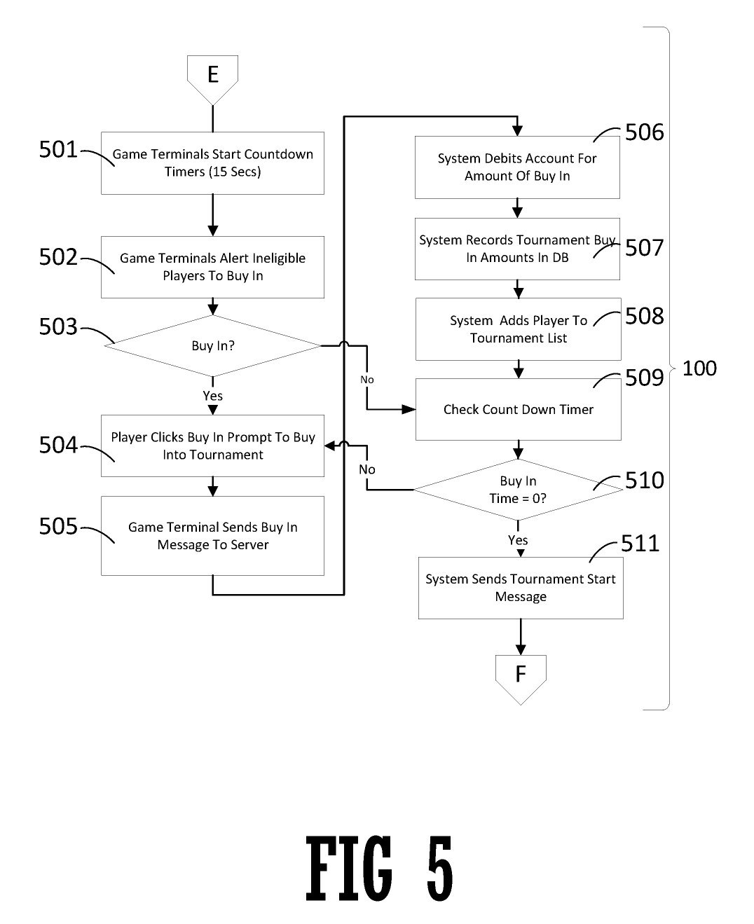

FIG. 6 is a continuation of a flow chart of an embodiment of the Promotional Tournament System.

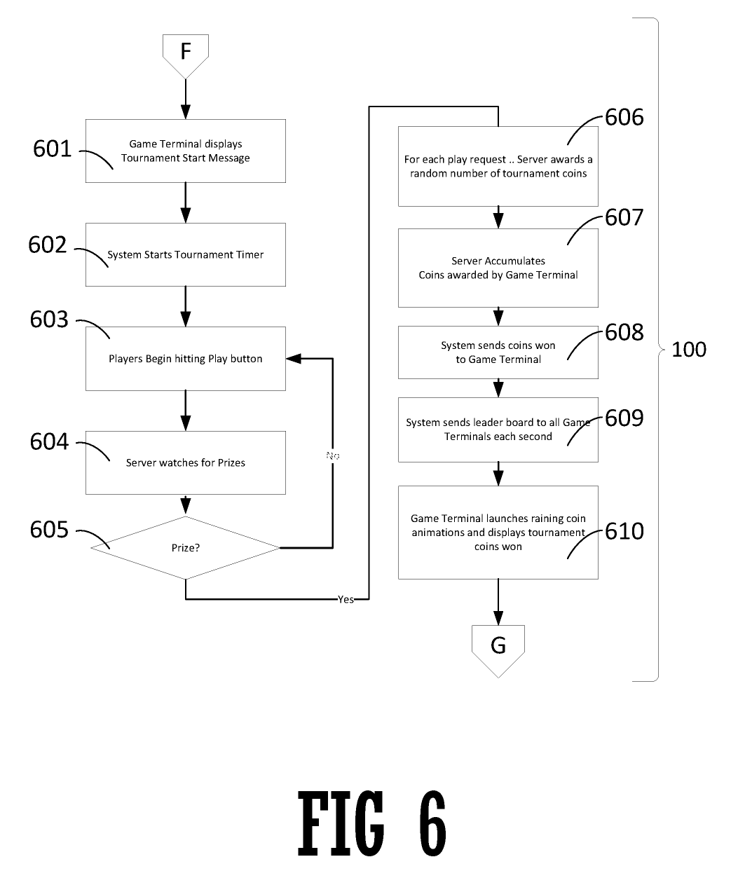

FIG. 7 is a continuation of a flow chart of an embodiment of the Promotional Tournament System.

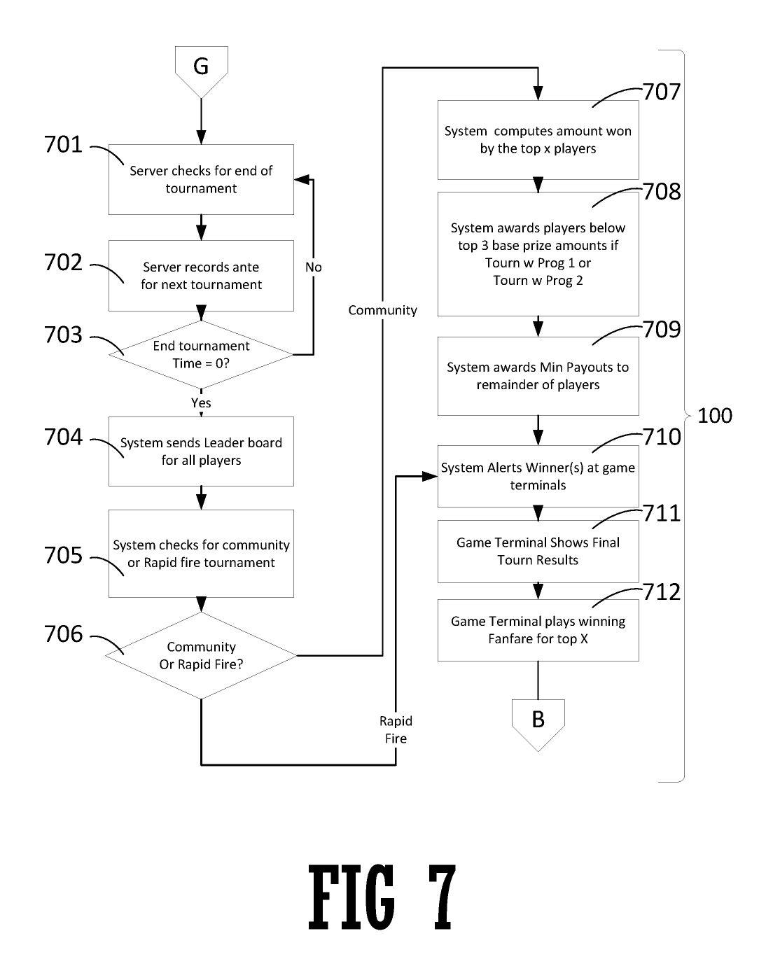

FIG. 8 is a continuation of a flow chart of an embodiment of the Promotional Tournament System.

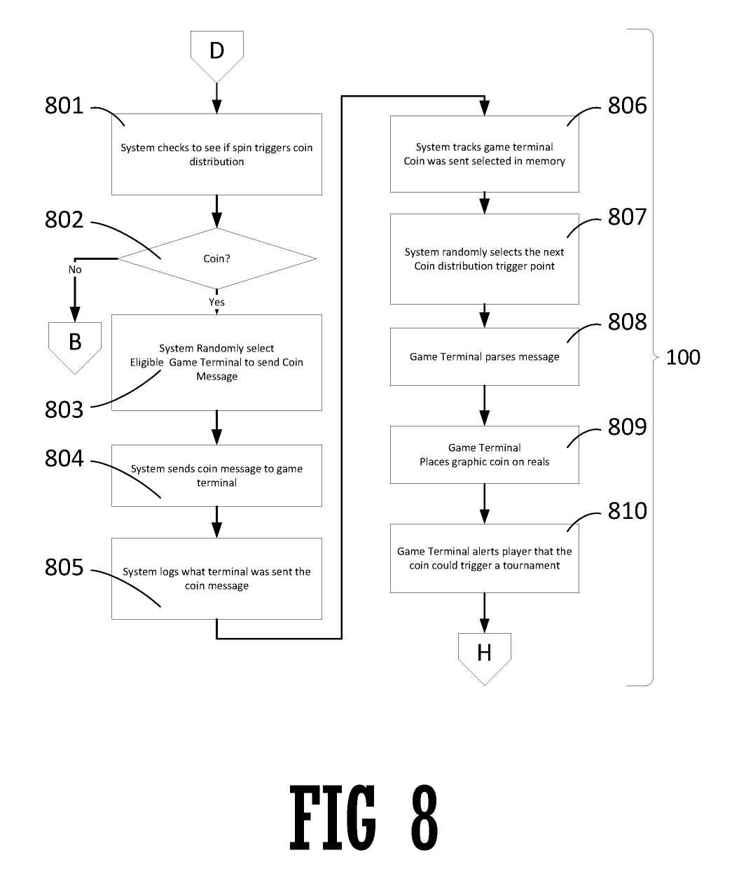

FIG. 9 is a continuation of a flow chart of an embodiment of the Promotional Tournament System.

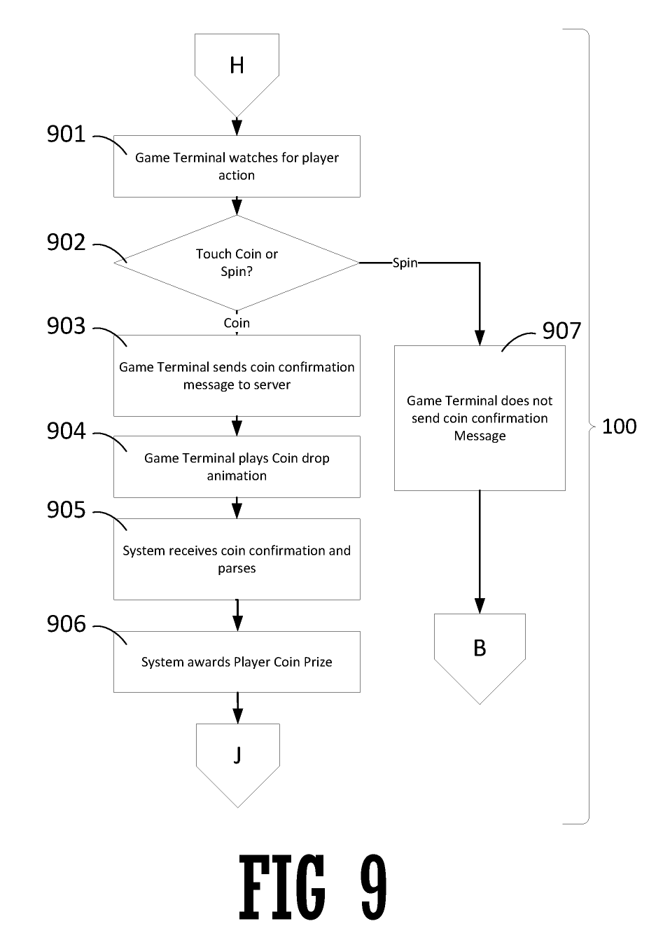

FIG. 10 is a continuation of a flow chart of an embodiment of the Promotional Tournament System.

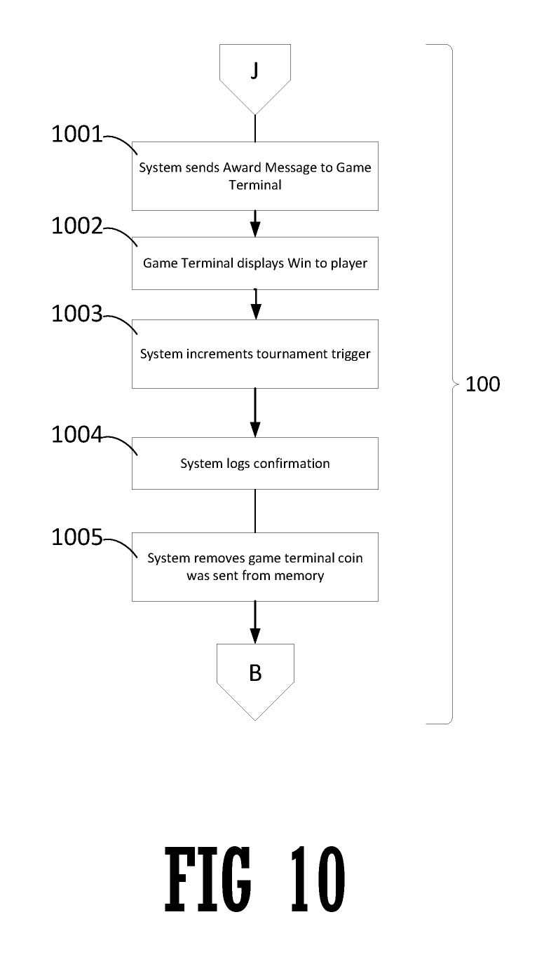

### DETAILED DESCRIPTION OF THE PREFERRED EMBODIMENTS

Embodiments of the Promotional Tournament System 100 are comprised of a game within a game. It is funded by the collection of an ante or funded by other means and the amount of payback to the player could be controlled exactly like a slot machine. The promotion is a self-funded promotional system that generates revenue. The Promotional Tournament System is comprised of a game, a game display, a game funding procedure, a game trigger, and an eligibility procedure.

Embodiments of the tournament promotion can be operated as either in-revenue or out of revenue. The embodiments can be configured to be active or inactive. The embodiments are self-contained and only couple to a game by accepting the ante, funding of the progressive, maintaining eligibility, and delivering tournament prize results that are exclusively independent from the games or the game math. The player must win prizes or meet a minimum spin requirement to maintain eligibility. A default number of spins or default amount of ante collected is used to trigger the event. The server sends alerts to the game terminal that results in a graphical coin displayed somewhere on the reels. The player must accept the coin via click or reel spin before it contributes to the game trigger. The coin method is configurable and may or may not be used. The tournament can be triggered by a collection of coins or a number of spins or ante collected based on a randomly selected amount respectively.

One embodiment will be offering multiple promotions for the cost of an ante per spin to the players. The promotion is a preset tournament ante per spin. The promotion will have separate configuration screens and can be turned on and off at the server site. The ante amount will adjust based upon this setting.

The players will be given a choice to participate in all or to select individual promotions. The player will be able to click on the eligibility icon and opt into or out of promotions. The promotions will be paid for by charging an ante and the amount of the ante will be determined by the promotions in which the players opt to participate. This option is configurable and will have the following options: 1) Player required to participate in all promotions—charged 0.05 per spin; 2) player required to participate in tournament—charged 0.03 per spin; and 3) Player allowed to opt out of other incentive promotions—reduces charge to $0.02 per spin. Again, the amount of each promotion and the charge for the ante is configurable. The above referenced ante amounts are for example only.

Embodiments of the Promotional Tournament System comprise various tournament types. The floor wide tournament system is designed to support three types of tournaments: 1) community tournaments; 2) rapid-fire tournaments, and 3) out-of-revenue tournaments. The Random Rewards promotion accompanies both community and rapid-fire tournaments respectively. The Promotional Tournament System can be played throughout the casino floor regardless of number of machines, denom, or games being played. The embodiments of the Promotional Tournament System also comprise a data connection means so that the embodiments can be operated centrally with multiple sites linking to a centralized tournament which pays in the same method as the localized tournament system. In other words, in another embodiment the promotional tournament system comprises a data connection means, two or more remote promotional tournament systems, and a centralized tournament server so that the two or more remote promotional tournament systems can be operated independently but linked to the centralized tournament server which pays in the same method manner across all instances of remote promotional tournament systems.

In a community tournament embodiment, the tournament will pay all players, and all participants will receive a participation prize. The top three players will be awarded a percentage of the prizes—(the participation prize×number of players), For example, in one embodiment, the 1^{st} place player will receive 50%, the 2^{nd} place player will receive 30%, and the 3^{rd} place player will receive 20%. All other players will receive a participation prize. The percentage awarded to the players is configurable at the server.

In a rapid-fire tournament, the tournament is a winner takes all tournament. The tournament type will pay a single prize to the winner.

An Out of Revenue tournament is used by the location for promotional purposes. The site will pay for the cost of the tournament and will be able to award either product or cash prizes. The system will track the play in the database, but the tournament is free and will not impact the cash accounting nor will the player be charged. The out of revenue tournament is used mostly for promotional purposes.

Countdown timers for both the community tournament, out of revenue, and the rapid-fire tournament will be used and players will be permitted to join during a set period. In one embodiment, the buy-in timer will be 30 seconds, which includes 20 seconds to buy-in and 10 seconds to reveal how much the players are competing to win. The community tournament timer is set to 45 seconds, and the rapid-fire tournament time is set to 25 seconds. These times are all configurable at the server.

The game is a game within a Game. A multi-tiered progressive game is displayed on a screen including a wall mounted screen or a game terminal. The top two prizes are rolling progressives that have completely configurable seed. When the prizes are awarded, everyone that is eligible (as defined below) is paid evenly. The bottom two prizes are random winners and are treated like a typical hot seat. The random winner option is configurable and can offer more than two prizes. A random winner is a player that is actively playing on the system that is selected to win a single prize. When the game is triggered from the server, a distinctive sound is played to alert the player of the impending spin. When the prize is awarded, the game issues a distinctive alert such as displaying a fan fair and the amount awarded. The Random Winner is alerted on the game terminal and the game terminal meters are incremented the amount of the prize.

The game display is comprised of one (1) line, three (3) reel slot game, or promotional wheel. In this game if a user hits 7-7-7, the user is awarded the top prize. Distinct symbols will be used to identify a Random Winner, a Community Tournament, a Rapid-Fire tournament, or an out of revenue tournament.

The game funding procedure is comprised of a configurable ante collected from each spin. The collection of the ante is configurable to allow the player to opt out of contributing to the game within game. Opting out of the contribution will make the player ineligible for the prize. A percentage of the ante is contributed to the top two prizes like a normal progressive game. In one embodiment, the contribution is one percent (1%).

The game trigger is comprised of a preconfigured number of spins and a random spin is selected between the from-value and to-value of spins entered into the game configuration file. For example, the game can be configured to go off between two hundred (200) and five hundred (500) spins. The server would select a random number between the spins. In one example, the server would randomly select 225 to use as the random number of spins. After the random winner or tournament is triggered, the system selects another random number between the preset configuration settings.

The eligibility procedure is comprised of an eligibility meter. The eligibility meter is placed in various locations on the game button panel or screen. Eligibility is based upon a server-based algorithm that measures a player's actions and sets the eligibility. The current embodiment uses a dinosaur egg and if hatched the player is eligible, if half hatched the players eligibility is about to expire, and if not hatched then the player is not eligible. The meter also indicates if the player is participating in the promotion and identifies the amount of the ante. The egg stays unhatched if the player does not participate. The purpose of the eligibility procedure is to ensure that active players are winning the prizes and the game terminal loiterers are not creating frustration on the floor by not playing and still winning the prizes generated by other player's contributions.

The average payout of the Promotional Tournament System is an amount specified by the server. The Promotional Tournament System exists in RNG, Lottery, and bingo forms. Many tiers of prizes are to be given away in each promotion. The Promotional Tournament System may or may not contain losers, but in one embodiment the losers are not normally revealed to the players. Multiple configurations of the math distribution were created to accommodate game play load.

In an embodiment of the Random Winner Machine Promotion, the Random Winner

Machine Promotion comprises a server; a game terminal; a spin counter; a user starting procedure or means; a promotion procedure or means; a game play procedure or means; and a winner notification procedure or means. The Random Winner promotion can be run independently of the multi-tiered tournament system but is designed to run in parallel with all but the out of revenue option.

The user starting procedure comprises: to start a game, the user presses the play button which increments a user spin counter; a user enters a starting token (a unique personal identification number (PIN), cash, or ticket) via a game terminal 101; and a server verifies 102 that the starting token is valid, 103, and if the starting token is not valid, the server provides an error message to the user via the game terminal 108 and returns to allow a user to start a new game 101.

The promotion procedure comprises: if the starting token is valid, the server checks for the game type granted to the PIN 104; if the starting token is valid for a multiplayer game 105, a multigame screen 106 is displayed to the user; the desired game is launched 107; the sever checks 201 whether the user has selected promotions 202; if no promotions are available, the server sets the game as the default game 203; the server alerts the game terminal of which promotions are to be run 204; if promotions have been selected display the promotion or promotions on the game terminal by displaying an eligibility icon 205; or if no promotion is selected the game terminal defaults to a default game 206; at the beginning of the game all players are eligible for the promotional tournament, so the promotional icon displays as ineligible upon launch, and an eligibility timer is started 207; and if the eligibility timer is zero 208 the server sets the player as ineligible to participate in any promotions 209.

The game play procedure comprises: the player presses the play button 301; the server increments the play spin counter 302; the server checks for a win or 5 spins 303; if the spin counter is equal to five (5) or the user wins a prize 304, user eligibility is set to true 305; the game terminal sends spin information to the server 306, and the server stores play results in a database 307, the server contributes to the progressive pot 308, and increments the spin counter 401.

Next the server determines if there is a coin or tournament spin target hit 402, and if so, the server determines if it is a tournament or coin winner 403, and if not checks if the player is logged out 404. If a tournament is selected, the server sets the next tournament point 405. Then the server pulls a ticket from a ticket set. The server determines if the ticket is a winner or loser 407. If the ticket is a loser 412, the system proceeds to check if the player has logged out 404. If the ticket is a winner, the system notifies eligible players of the tournament 408, and creates a tournament list of eligible players 409. If the game is a coin game, the server proceeds to the coin tournament procedure. After the server checks whether the user has logged out 404, if the user has logged out 410, the game terminal returns to attract a multigame 411 and this ends the Promotional Tournament System 407.

After the server creates a tournament list of eligible players 409, the game terminals start a countdown timer (15 secs) 501, the game terminals alert ineligible players to buy in 502. If the player does not buy in 503, the game proceeds to check the countdown timer 509. If the player does buy in 503, the player clicks the Buy In prompt to buy into tournament 504. Next, the game terminal sends a Buy In message to the server 505, the server debits the players account for amount of buy in 506, the server records the tournament buy in amounts in the database 507, the system adds the player to tournament list 508, and checks the countdown timer 509. If the countdown timer is not equal to zero 510, the game returns to allow the player to click Buy in prompt to buy into tournament 504. If the countdown timer is equal to zero 510, the system sends a tournament start message to the game terminals 511.

After the server sends a tournament start message 511, the server directs the game terminals to display the start of tournament message 601, starts a tournament timer 602, and the players begin by hitting the play button 603. During play, the server monitors the tournament for prizes 604. If the server does not detect a prize, the game returns to the players begin by hitting the play button 603. If the server detects a prize 605, for each play request the server awards a random number of tournament coins 606, the server accumulates coins awarded by game terminal 607, the system sends coins won to game terminal 608, the system sends leader board to all GT's each second 609, the game terminal launches raining coin animations and displays tournament coins won 610, the server checks for the end of tournament 701, and the server records ante for next tournament 702. If the tournament timer has not reached zero 703, the game returns to checks for the end of tournament 701.

If the tournament timer has reached zero 703, the system sends a leader board for all players to displays 704, and the system checks for a community, out of revenue, or rapid-fire tournament 705.

If the tournament is a community tournament 706, the system computes amount won by the top x players 707, the system awards players below top 3 base prize amounts if tournament with Prog 1 or tournament with Prog 2 708, the system awards Min Payouts to remainder of players 709, and the system alerts winner(s) at game terminals 710. If the tournament is a rapid-fire tournament 706, the system proceeds to alerting a winner at a game terminal 710. If the tournament is an out of revenue tournament then the system will store the play transactions separately and not charge the player for the tournament. The leader board and tournament play will be the same as both the rapid-fire tournament and the community tournament.

Once the system alerts winner(s) at game terminals 710, the game terminal shows final tournament results 711, the game terminal plays winning fanfare for top X 712, and the game proceeds to the give the player an opportunity to press the play button 301.

If the tournament to be played is a coin game 403, System checks to see if spin triggers coin distribution 801. If the spin did not trigger a coin distribution 802, the game proceeds to the give the player an opportunity to press the play button 301. If the spin did trigger a coin distribution 802, the system randomly selects an eligible game terminal to send a coin message 803, sends a coin message to the selected game terminal 804, the system logs what terminal was sent the coin message 805, the system tracks the game terminal that the coin was sent in memory 806, the system randomly selects the next coin distribution trigger point 807, the game terminal parses message 808, the game terminal places graphic coin icons on the reals 809, the game terminal alerts player that the coin could trigger a tournament 810, and the game terminal watches for player action 901.

The player selects the coin icon 902, the game terminal sends a coin confirmation message to the server 903, the game terminal plays a coin drop animation 904, the system receives coin confirmation and parses the message 905, the system awards the player a coin prize 906, the system sends an award message to game terminal 1001, the game terminal displays a win to the player 1002, the system increments the tournament trigger 1003, the system logs the confirmation 1004, the system removes the game terminal coin was sent from memory, and the game proceeds to the give the player an opportunity to press the play button 301.

If the player selects the spin or reel icon 902, the game terminal does not send a coin confirmation message 907, the game proceeds to the give the player an opportunity to press the play button 301.

What is claimed is:

1) A promotional tournament system comprising a server; a game terminal; a spin counter; a user starting means; a promotion means; a game play means; and winner notification means that can be played throughout the casino floor regardless of number of machines, denom, or games being played.

2) The promotional tournament system described in claim 1 further comprising a play button that increments a user spin or amount of ante collected counter; an input means for verifying a starting token wherein the server verifies that the starting token is valid and provides an error message to a game terminal if the token is not valid or provides the game type granted to the token.

3) The promotional tournament system described in claim 2 wherein the promotion means comprises a means to grant a player with a valid multiplayer game starting token the right to play a multiplayer game; wherein the server displays a multigame screen user; wherein the desired multiplayer game is launched.

4) The promotional tournament system described in claim 3 wherein the sever checks whether the user has selected promotions; wherein the server alerts the game terminal of which promotions are to be run; wherein if promotions have been selected display the promotion or promotions on the game terminal by displaying an eligibility icon or if no promotion is selected the game terminal defaults to a default game.

5) The promotional tournament system described in claim 4 wherein the server defaults to displaying a promotion icon upon launch; wherein an eligibility timer is started and begins to decrement; and wherein if the eligibility timer is zero, the server sets the player as ineligible to participate in any promotions.

6) The promotional tournament system described in claim 5 comprising a game play procedure comprising initiation of the server by the press of the play button; wherein the server increments a configured spin counter; wherein the server checks for a win or five spins; wherein if the spin counter is equal to five or the user wins a prize, wherein the server sets user eligibility is set to true; wherein the game terminal sends spin information to the server, wherein the server stores play results in a database, wherein the server contributes to a progressive pot, wherein the server increments the spin counter.

7) The promotional tournament system described in claim 6 comprising a data connection means, two or more remote promotional tournament systems, and a centralized tournament server so that the two or more remote promotional tournament systems can be operated independently but linked to the centralized tournament server which pays in the same method manner across all instances of remote promotional tournament systems.

8) The method of running a promotional tournament system comprising the following steps:
a. first, a user selects or presses a play button;
b. next, a user spin counter is incremented;
c. next, the server verifies the user starting token and determines whether the token is valid and provides an error message to a game terminal if the token is not valid;
d. next, the server determines what game type is permitted by the starting token;
e. next, the server grants a player with a valid multiplayer game starting token the right to play a multiplayer game, or a singly installed game.
f. next, the server displays a multigame screen for the user to select a game;
g. next, the server launches the selected multiplayer game;
h. next, the sever checks whether the user has selected promotions;
i. next, the server alerts the game terminal of which promotions to be run;
j. next, the server determines which promotions have been selected and displays the promotion or promotions on the game terminal by displaying an eligibility icon or if no promotion is selected the game terminal defaults to a default game;
k. next, the server displays a promotion icon upon launch;
l. next, the server begins an eligibility timer which immediately begins to decrement;
m. next, the server determines if the eligibility timer is zero, and if the eligibility timer is zero sets the player as ineligible to participate in any promotions;
n. next, the server beings game play upon selection or pressing of the play button;
o. next, the server increments a plan spin counter;
p. next, the server checks for a win or whether the user as taken five spins;
q. next, the server determines if the spin counter is equal to five or the user wins the game;
r. next, if the spin counter is equal to file or the user won the game, the server stores play results in a database, wherein the server contributes to a progressive pot;
s. next, the server increments the spin counter;
t. next, the server determines if there is a coin or tourney spin target hit, and if so, the server determines if it is a tournament or random winner, and if not checks if the player is logged out and the game is terminated;
u. next, if a tournament is selected, the server sets the next tournament point;
v. next, the server pulls a ticket from a ticket set and the server determines if the ticket is a winner or loser;
w. next, if the ticket is a loser, the system proceeds to check if the player has logged out; If the ticket is a winner, the system notifies eligible players of the tournament, and creates a tournament list of eligible players; the winner is paid based upon a tiered payout algorithm;
x. next, if the game is a coin game, the server proceeds to the coin tournament procedure after which the server checks whether the user has logged out, and if the user has logged out, the game terminal returns to attract a multigame and thus ends the game.
